(19) United States
(12) Patent Application Publication
(10) Pub. No.: US 2009/0085842 A1
(43) Pub. Date: Apr. 2, 2009

(54) PLASMA DISPLAY APPARATUS

(75) Inventors: Yongsin KIM, Seoul (KR); Junghoan KIM, Seoul (KR); Kwangseon LEE, Seoul (KR); Inyoung LEE, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 12/026,607

(22) Filed: Feb. 6, 2008

(30) Foreign Application Priority Data
Oct. 1, 2007 (KR) 10-2007-0098949

(51) Int. Cl. G09G 3/28

(52) U.S. Cl. 345/71

(57) ABSTRACT

A plasma display apparatus includes a plasma display panel (PDP) and electrode drivers. The electrode drivers supply driving voltages to scan electrodes and sustain electrodes of the PDP through a connection circuit which includes a base film and electrode line groups electrically separated from one another. Electrodes from a first electrode line group are connected to sustain electrodes of a first sustain electrode group and electrode lines from a second electrode line group to sustain electrodes of a second sustain electrode group. During a predetermined period of an address period, a first bias voltage is applied to the sustain electrodes of the first sustain electrode group and a second bias voltage different from the first bias voltage is applied to the sustain electrodes of the second sustain electrode group.

This nonprovisional application claims priority under 35 U.S.C. §119(a) on Patent Application No. 2007-0098949 filed in Republic of Korea on Oct. 1, 2007 the entire contents of which are hereby incorporated by reference.

### BACKGROUND

1. Technical Field

This document relates to a plasma display apparatus.

2. Related Art

In general, a plasma display panel (hereinafter, referred to as a “PDP”) is adapted to display images by exciting phosphors with ultraviolet rays of 147 nm, which are generated when a mixed inert gas of He+Xe or Ne+Xe is discharged.

FIG. 1 is a perspective view illustrating an example structure of a three-electrode AC surface discharge type PDP having a discharge cell structure in which cells are arranged in a conventional matrix form. Referring to FIG. 1, the three-electrode AC surface discharge type PDP 100 comprises a scan electrode 11 and a sustain electrode 12 formed on a front substrate 10, and address electrodes 22 formed on a rear substrate 20. Each of the scan electrode 11 and the sustain electrode 12 includes a transparent electrode 11a or 12a, made of, for example, indium-tin-oxide (ITO). Metal bus electrodes 11b and 12b for decreasing resistance are formed on the transparent electrodes 11a and 12a, respectively. An upper dielectric layer 13a and a protection film 14 are laminated over the front substrate 10 on which the scan electrode 11 and the sustain electrode 12 are formed. Wall charges generated at the time of a plasma discharge are accumulated on the upper dielectric layer 13a. The protection film 14 serves to prevent damage to the upper dielectric layer 13a due to sputtering generated at the time of a plasma discharge and increase emission efficiency of secondary electrons. The protection film 14 is generally formed from magnesium oxide (MgO).

A lower dielectric layer 13b and barrier ribs 21 are formed over the rear substrate 20 on which the address electrodes 22 are formed. A phosphor layer 23 is coated on the surfaces of the lower dielectric layer 13b and the barrier ribs 21. The address electrodes 22 are formed to intersect the scan electrode 11 and the sustain electrode 12. The barrier ribs 21 are formed parallel to the address electrodes 22, and serve to prevent ultraviolet rays generated by a discharge and a visible ray from leaking to neighboring discharge cells. The phosphor layer 23 is excited with ultraviolet rays generated at the time of a plasma discharge and generates one visible ray of red (R), green (G) or blue (B). A mixed inert gas for a discharge, such as He+Xe or Ne+Xe, is injected into a discharge space of a discharge cell partitioned by the barrier ribs 21 between the front substrate 10 and the rear substrate 20. A driving method of the conventional PDP constructed above is described below with reference to FIG. 2.

FIG. 2 shows an example waveforms for driving the PDP. As shown in FIG. 2, the driving time period includes a reset period, an address period, and a sustain period. The reset period includes a set-up period and a set-down period.

In the set-up period, a ramp-up pulse is applied to the scan (Y) electrode, so that positive wall charges are accumulated on the sustain (Z) electrode and the address (X) electrode and negative wall charges are accumulated on the scan (Y) electrode.

In the set-down period, wall charges, which have been excessively accumulated by means of the ramp-up pulse, are uniformly reduced to a certain level by the application of a ramp-down pulse.

In the address period, an address discharge is generated by a scan pulse applied to the scan (Y) electrode and a data pulse applied to the address (X) electrode, and a sustain voltage Vs applied to the sustain (Z) electrode. At this time, the bias voltage Vs applied to the sustain (Z) electrode is such that it does not generate a discharge together with the scan pulse applied to the scan (Y) electrode.

In the sustain period, a sustain pulse is alternately applied to the scan (Y) electrode and the sustain (z) electrode, thus generating a sustain discharge.

FIG. 3 illustrates the state of wall charges according to the driving waveform. In FIG. 3, the state of wall charges formed by a set-up discharge generated by the ramp-up pulse in the set-up period is represented by (a). Significant wall charges are formed on the scan (Y) electrode, the sustain (z) electrode, and the address (X) electrode by means of the ramp-up pulse.

In FIG. 3, the state of wall charges formed according to the discharge process by the ramp-down pulse in the set-down period is represented by (b). Wall charges of each cell become uniform while wall charges excessively accumulated by the ramp-down pulse are removed to a certain level.

In FIG. 3, the state of wall charges right after the application of the scan pulse and the data pulse to the scan (Y) electrode and the address (X) electrode, respectively, in the address period is represented by (c). The state of wall charges is reversed compared with the state of wall charges in the set-down period, as represented by (b).

In FIG. 3, the state of wall charges within the cell some time after the address discharge has occurred in the address period is represented by (d). The wall charges generated by the address discharge, as represented by (c), is substantially maintained for some time.

### SUMMARY

In one general aspect, a plasma display apparatus includes a plasma display panel (PDP) and electrode drivers. The plasma display panel includes a front substrate on which scan electrodes and sustain electrodes are arranged and a rear substrate on which address electrodes are arranged. The front substrate includes a first dielectric layer covering the scan electrodes and sustain electrodes and a protective film located on the first dielectric layer. The lower substrate includes a second dielectric layer covering the address electrodes and barrier ribs. The sustain electrodes are divided into sustain electrode groups. The electrode drivers supply driving voltages to the scan electrodes and the sustain electrodes through a connection circuit which includes a first base film and electrode line groups electrically separated from one another. The electrode lines from a first electrode line group are connected to sustain electrodes of a first sustain electrode group and electrode lines from a second electrode line group are connected to sustain electrodes of a second sustain electrode group. During a predetermined first period of an address period, a first bias voltage is applied to the sustain electrodes of the first sustain electrode group by the first electrode line group, and a second bias voltage different from the first bias voltage is applied to the sustain electrodes of the second sustain electrode group by the second electrode line group.

In another general aspect, a plasma display apparatus includes a plasma display panel and electrode drivers. The plasma display panel includes a front substrate on which scan electrodes and sustain electrodes are arranged and a rear substrate on which address electrodes are arranged. The front substrate includes a first dielectric layer covering the scan electrodes and sustain electrodes and a protective film located on the first dielectric layer. The lower substrate includes a second dielectric layer covering the address electrodes and barrier ribs. The sustain electrodes are divided into sustain electrode groups. The electrode drivers supply driving voltages to the scan electrodes and the sustain electrodes through a connection circuit which includes a first base film and electrode line groups electrically separated from one another. Electrode lines from a first electrode line group are connected to sustain electrodes of a first sustain electrode group and electrode lines from a second electrode line group are connected to sustain electrodes of a second sustain electrode group. The sustain electrodes of the first and the second sustain electrode groups are arranged such that each of the sustain electrodes of the first sustain electrode group is adjacent to sustain electrodes of the second sustain electrode group and not adjacent to sustain electrodes of the first sustain electrode group

Implementations may include one or more of the following features. For example, the first and second electrode line groups may be disposed on opposite sides of the first base film. The connection circuit may include a flexible printed circuit board. The connection circuit may further include a second base film and the first and second electrode line groups may be respectively located on the first and second base films. The number of the electrode line groups may be the same as that of the sustain electrode groups. For example, there may be two sustain electrode groups and two electrode line groups, while the PDP may include on the order of 1000 sustain electrode lines.

Each of the scan electrodes corresponds to a sustain electrode and scan pulses are supplied to scan electrodes corresponding to the sustain electrodes of the first sustain electrode group during the predetermined first period of the address period. The second bias voltage may be lower than the first bias voltage. The second bias voltage may be a ground level. The first bias voltage may be substantially the same as a voltage of a sustain pulse applied to the sustain electrodes in a sustain period. During a predetermined second period of the address period, which is different from the predetermined first period, the first bias voltage may be applied to the sustain electrodes of the second sustain electrode group by the second electrode line group, the second bias voltage may be applied to the sustain electrodes of the first sustain electrode group by the first electrode line group, and scan pulses may be supplied to scan electrodes corresponding to the sustain electrodes of the second sustain electrode group.

Other features will be apparent from the following description, including the drawings, and the claims.

### BRIEF DESCRIPTION OF THE DRAWINGS

The implementation of this document will be described in detail with reference to the following drawings in which like numerals refer to like elements.

FIG. 1 is a perspective view illustrating an example structure of a three-electrode AC surface discharge type PDP having a discharge cell structure in which cells are arranged in a conventional matrix form;

FIG. 2 shows an example waveform for driving the PDP;

FIG. 3 is a diagram illustrating the example of the state of wall charges according to the driving waveform of FIG. 2;

FIG. 4 is a schematic view illustrating an example structure of a plasma display apparatus;

FIG. 5 shows an example waveform for driving a plasma display panel;

FIG. 6 is a view illustrating the state of wall charges formed by the waveform of FIG. 5;

FIG. 7 is a schematic view illustrating an example structure of a high resolution PDP; and

FIGS. 8a and 8b illustrate example structures of a FPC board connected to the sustain electrodes arranged in a PDP.

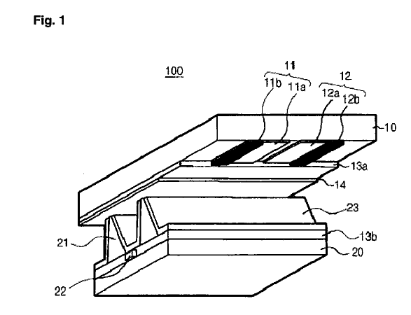

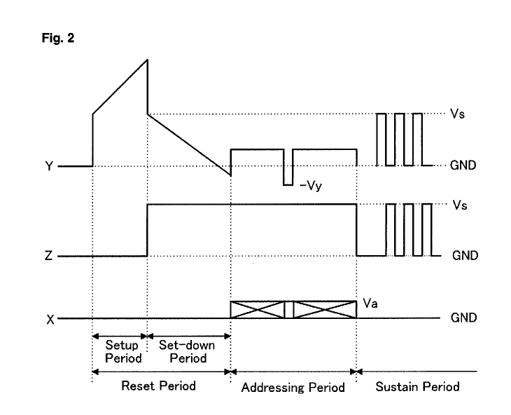

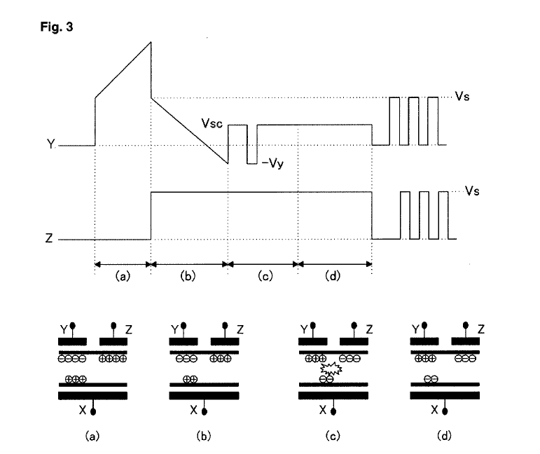

### DETAILED DESCRIPTION

Hereinafter, implementations of this document will be described in detail with reference to the attached drawings.

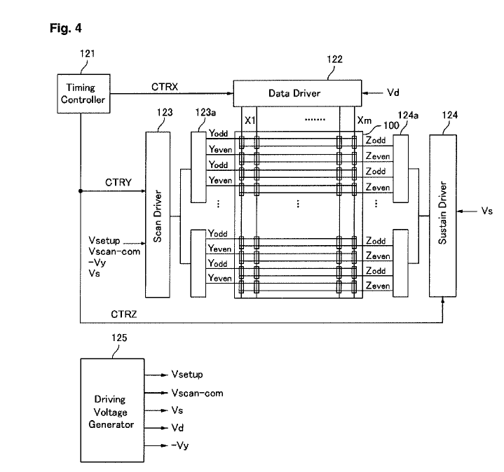

FIG. 4 is a schematic view illustrating an example structure of a plasma display apparatus.

As shown in FIG. 4, the plasma display apparatus includes a PDP 100, a data driver 122 for supplying data to address electrodes X1 to Xm formed in a rear substrate (not shown) of the PDP 100, a scan driver 123 for supplying driving voltages to scan electrodes Y through an FPC board 123a, a sustain driver 124 for supplying driving voltages to sustain electrodes Z (for example, common electrodes) through a FPC board 124a, a timing controller 121 for controlling the data driver 122, the scan driver 123, and the sustain driver 124 when the PDP is driven, and a driving voltage generator 125 for supplying driving voltages necessary for the respective drivers 122, 123, and 124.

The PDP 100 has a front substrate (not shown) and the rear substrate (not shown) attached together with discharge space therebetween. A number of electrodes (for example, the scan electrodes Y and the sustain electrodes Z) are formed on the front substrate. One scan electrode and one sustain electrode form a pair on the front substrate. The address electrodes X1 to Xm intersecting the scan electrodes Y and the sustain electrodes Z are formed on the rear substrate.

The data driver 122 receives image data. Before being supplied to the data driver 122, the image data is processed by an inverse gamma correction circuit (not shown), an error diffusion circuit (not shown) and so on, and then mapped to respective subfields by a subfield mapping circuit. The data driver 122 samples and latches data in response to a timing control signal CTRX generated from the timing controller 121, and supplies the data to the address electrodes X1 to Xm.

The scan driver 123 supplies a ramp-up waveform and a ramp-down waveform to the scan electrodes Y during a reset period under the control of the timing controller 121. The scan driver 123 also sequentially supplies a scan pulse Sp of a scan voltage −Vy to the scan electrodes Y while sustaining a scan bias voltage Vsc during an address period under the control of the timing controller 121.

The sustain driver 124 supplies bias voltages to the sustain electrodes z during the set-down and during the address period under the control of the timing controller 121. In one implementation, the sustain electrodes are divided into more than one groups and the sustain driver 124 applies a first bias voltage to any one of the sustain electrode groups and a second bias voltage different from the first bias voltage to the other sustain electrode groups for a predetermined period of the address period. This will be described in detail later.

Further, during the sustain period, a sustain driving circuit provided in the sustain driver 124 supplies a sustain pulse to the sustain electrodes Z while a sustain driving circuit provided in the scan driver 123 supplies the sustain pulse to the scan electrodes Y.

The timing controller 121 receives horizontal/vertical sync signals and clock signals, generates timing control signals CTRX, CTRY, and CTRZ for controlling operating timings and synchronization of the drivers 122, 123, and 124 in the reset period, the address period, and the sustain period, and supplies the timing control signals CTRX, CTRY, and CTRZ to corresponding drivers 122, 123, and 124, thus controlling the drivers 122, 123, and 124.

Meanwhile, the data control signal CTRX includes a sampling clock for sampling data, a latch control signal, and a switch control signal for controlling on/off time of a sustain driving circuit and a driving switch element. The scan control signal CTRY includes a switch control signal for controlling on/off time of a sustain driving circuit and a driving switch element within the scan driver 123. The sustain control signal CTRZ includes a switch control signal for controlling on/off time of a sustain driving circuit and a driving switch element within the sustain driver 124.

The driving voltage generator 125 generates a set-up voltage Vsetup, a common scan voltage Vscan-com, the scan voltage −Vy, the sustain voltage Vs, the data voltage Vd and so on. The driving voltages may vary depending on the composition of a discharge gas or a discharge cell structure.

The scan electrodes may be divided into scan electrode groups and the sustain electrodes may be divided into sustain electrodes. For example, as shown in FIG. 4, the scan electrodes and the sustain electrodes may be divided into two groups. The first group is the group of odd-numbered electrodes and the second group is the group of even-numbered electrodes. A pair of sustain and scan electrodes from the first group is adjacent to pairs of sustain and scan electrodes from the second group but is not adjacent to a pair of sustain and scan electrodes from the first group.

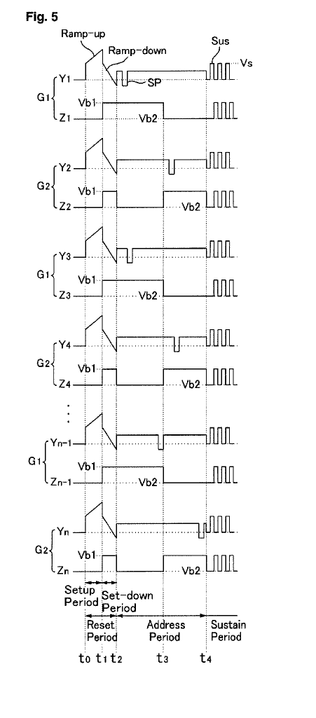

An example driving method of the plasma display apparatus constructed above is described below with reference to FIG. 5.

FIG. 5 shows an example waveform for driving the plasma display apparatus as shown in FIG. 4. As shown in FIG. 5, the pairs of the sustain (Z) electrodes and scan (Y) electrodes are divided into a first electrode group G1 and a second electrode group G2.

In this case, the first electrode group G1 includes scan electrodes to which the scan pulse is supplied temporally during the first half of the address period, and the second electrode group G2 includes scan electrodes to which the scan pulse is supplied temporally during the second half of the address period.

The first electrode group G1 may include odd-numbered electrode lines, and the second electrode group G2 may include even-numbered electrode lines.

Grouping of electrodes other than that shown in FIG. 5 is possible. For example, the electrodes may be divided into more than two electrode groups.

Referring to FIG. 5, during the set-up period t0˜t1 of the reset period, sustain electrodes are sustained to the ground level, and the scan electrodes are supplied with a ramp-up pulse at the same time. During the set-down period t1˜t2 of the reset period, the sustain electrodes are supplied with a first bias voltage Vb1, and the scan electrodes are supplied with a ramp-down pulse at the same time.

Then, during the address period, sustain electrodes from the first electrode group Z_{1, 3, 5,} and sustain electrodes from the second electrode group Z_{2, 4, 6,} are supplied with different driving voltages.

In more detail, during the first half t2˜t3 of the address period, the sustain electrodes from the first electrode group Z_{1, 3, 5, . . .} are sustained to the first bias voltage Vb1 and the scan electrodes from the first electrode group are supplied with the scan pulse Sp, so that an address discharge is performed. During the second half t3˜t4 of the address period, the sustain electrodes that form the first electrode group Z_{1, 3, 5, . . .} are supplied with a second bias voltage Vb2 lower than the first bias voltage and the scan electrodes from the first electrode group are sustained to the scan bias voltage.

The first bias voltage Vb1 is substantially the same as a voltage of the sustain pulse, which is alternately applied to the scan electrode and the sustain electrode in the sustain period after the address period. Further, the second bias voltage can be higher than the ground level. If the second bias voltage is less than the ground level, an erroneous discharge may occur due to the difference between the voltage of the data pulse applied to the address electrode X and the second bias voltage Vb2.

The sustain electrodes from the second electrode group Z_{2, 4, 6, . . .} are supplied with the second bias voltage Vb2 during the first half t2˜t3 of the address period. After that, during the second half t3˜t4 of the address period, the scan electrodes from the second electrode group are supplied with the scan pulse Sp while the sustain electrodes from the second electrode group are supplied with the first bias voltage Vb1, so that address discharge is generated.

Thereafter, in the sustain period, the sustain pulse Sus is alternately applied to the whole scan electrodes and the whole sustain electrodes so that sustain discharge is generated.

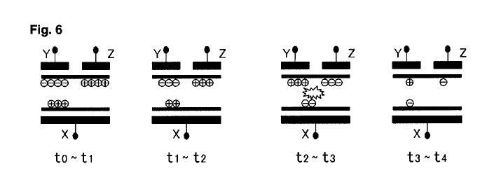

FIG. 6 illustrates the state of wall charges formed on the electrodes from the first sustain electrode group according to the driving method of FIG. 5.

Referring to FIG. 6, if the second bias voltage Vb2 lower than the first bias voltage Vb1 is applied to the sustain electrodes from the first electrode group Z_{1, 3, 5, . . .} in the second half t3˜t4 of the address period, some wall charges that have been accumulated on the electrodes are lost. Such weakened wall charges do not influence the address discharge performed by the adjacent electrodes from the second electrode group during the second half t3˜t4 of the address period, so that stable discharge can be performed.

By the same reason, though not shown in the drawing, as the sustain electrodes form the second electrode group Z_{2, 4, 6, . . .} are also applied with the second bias voltage Vb2 lower than the first bias voltage Vb1 during the first half t2˜t3 of the address period, some of the wall charges accumulated on the second-half sustain electrode group are lost. Accordingly, the address discharges by the adjacent electrodes from the first electrode group are less influenced by the wall charges accumulated on the electrodes from the second electrode group during the first half of the address period. Therefore, stable discharge can be generated.

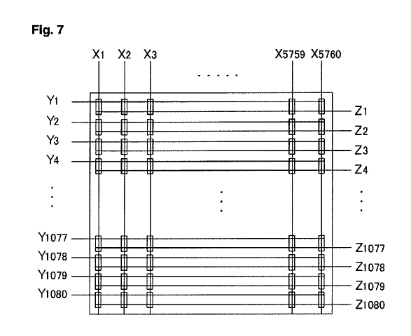

This driving method can prevent addressing erroneous discharge more effectively in the case of a PDP having, in particular, a high resolution as shown in FIG. 7. In other words, this is because in the case of a PDP having high resolutions, electrodes arranged in neighboring cells are easily influenced at the time of address discharge since the distance between the cells is close to one another.

A PDP of high resolutions may have at least 1000 scan and sustain electrodes lines. In this case, the resolutions may be 1080*1920 or more.

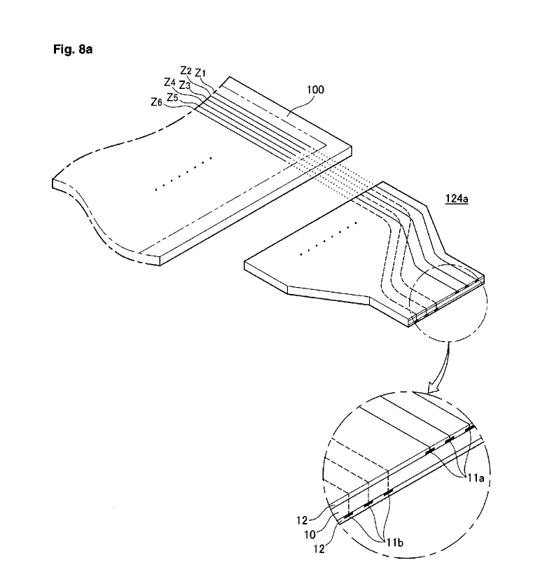

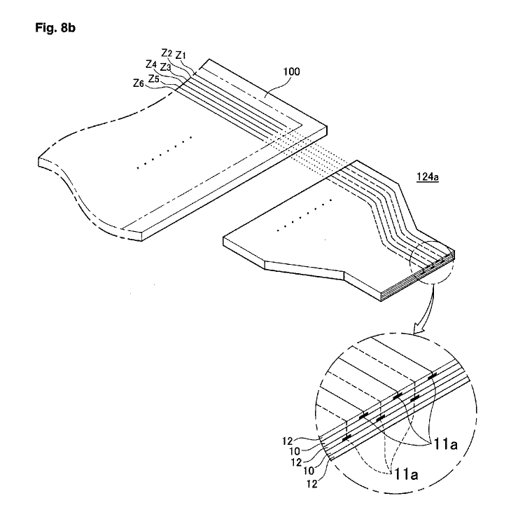

FIGS. 8a and 8b illustrate example structures of a FPC board connected to the sustain electrodes arranged in the PDP.

As shown in the drawing, electrode layers arranged in a FPC board 124a are electrically separated from one another in order to apply different driving voltages to an odd line sustain electrode group Z_{1, 3, 5, . . .} and an even line sustain electrode group Z_{2, 4, 6,.} In other words, as shown in FIG. 8a, the FPC board 124a includes a base film 10 made of polyamide, a first electrode line group 11a and a second electrode line group 11b patterned on both sides of the base film, and a protection layers 12 formed on both sides of the base film to cover the first and second electrode line groups 11a and 11b. In another implementation, as shown in FIG. 8b, the FPC board 124a includes two base films 10 made of polyamide, a first electrode line group 11a and a second electrode line group 11b patterned on the two base films, respectively, and protection layers 12 formed over the base films to cover the first and second electrode line groups 11a and 11b.

Only two electrode line groups are shown in FIGS. 8a and 8b as an example. It is, however, to be noted that the number of the electrode line groups may vary depending on the number of sustain electrode groups arranged in a PDP. For example, when the number of sustain electrode groups is three, three electrode line groups of the FPC board, which is the same as that of the sustain electrode groups, can be disposed on the base film.

The above FPC board structure can also be used to apply drive signals to scan electrodes.

Other implementations are within the scope of the following claims.

What is claimed is:

1. A plasma display apparatus, comprising:
a plasma display panel (PDP) comprising a front substrate on which scan electrodes and sustain electrodes are arranged and a rear substrate on which address electrodes are arranged, the front substrate comprising a first dielectric layer covering the scan electrodes and sustain electrodes and a protective film located on the first dielectric layer, the lower substrate comprising a second dielectric layer covering the address electrodes and barrier ribs, with the sustain electrodes being divided into sustain electrode groups; and
electrode drivers for supplying driving voltages to the scan electrodes and the sustain electrodes through a connection circuit comprising a first base film and electrode line groups electrically separated from one another, with electrode lines from a first electrode line group being connected to sustain electrodes of a first sustain electrode group and electrode lines from a second electrode line group being connected to sustain electrodes of a second sustain electrode group,
wherein, during a predetermined first period of an address period, a first bias voltage is applied to the sustain electrodes of the first sustain electrode group by the first electrode line group, and a second bias voltage different from the first bias voltage is applied to the sustain electrodes of the second sustain electrode group by the second electrode line group.

2. The plasma display apparatus of claim 1, wherein the first and second electrode line groups are disposed on opposite sides of the first base film.

3. The plasma display apparatus of claim 1, wherein the connection circuit includes a flexible printed circuit board.

4. The plasma display apparatus of claim 1, wherein the connection circuit further comprises a second base film and the first and second electrode line groups are respectively located on the first and second base films.

5. The plasma display apparatus of claim 1, wherein the number of the electrode line groups is the same as that of the sustain electrode groups.

6. The plasma display apparatus of claim 1, wherein each of the scan electrodes corresponds to a sustain electrode, and scan pulses are supplied to scan electrodes corresponding to the sustain electrodes of the first sustain electrode group during the predetermined first period of the address period.

7. The plasma display apparatus of claim 7, wherein the second bias voltage is lower than the first bias voltage.

8. The plasma display apparatus of claim 6, wherein the second bias voltage is a ground level.

9. The plasma display apparatus of claim 6, wherein the first bias voltage is substantially the same as a voltage of a sustain pulse applied to the sustain electrodes in a sustain period.

10. The plasma display apparatus of claim 6, wherein, during a predetermined second period of the address period, which is different from the predetermined first period, the first bias voltage is applied to the sustain electrodes of the second sustain electrode group by the second electrode line group, and the second bias voltage is applied to the sustain electrodes of the first sustain electrode group by the first electrode line group, and scan pulses are supplied to scan electrodes corresponding to the sustain electrodes of the second sustain electrode group.

11. The plasma display apparatus of claim 1, wherein the number of the sustain electrode groups is two.

12. The plasma display apparatus of claim 1, wherein the sustain electrodes of the first and the second sustain electrode groups are arranged such that each of the sustain electrodes of the first sustain electrode group is adjacent to a sustain electrode of the second sustain electrode group and not adjacent to sustain electrodes of the first sustain electrode group.

13. The plasma display apparatus of claim 1, wherein the number of the whole sustain electrode lines arranged in the PDP is at least 1000.

14. A plasma display apparatus, comprising:
a plasma display panel (PDP) comprising a front substrate on which scan electrodes and sustain electrodes are arranged and a rear substrate on which address electrodes are arranged, the front substrate comprising a first dielectric layer covering the scan electrodes and sustain electrodes and a protective film located on the first dielectric layer, the lower substrate comprising a second dielectric layer covering the address electrodes and barrier ribs, with the sustain electrodes being divided into sustain electrode groups; and
electrode drivers for supplying driving voltages to the scan electrodes and the sustain electrodes through a connection circuit comprising a first base film and electrode line groups electrically separated from one another, with electrode lines from a first electrode line group being connected to sustain electrodes of a first sustain electrode group and electrode lines from a second electrode line group being connected to sustain electrodes of a second sustain electrode group,
wherein the sustain electrodes of the first and the second sustain electrode groups are arranged such that each of the sustain electrodes of the first sustain electrode group is adjacent to sustain electrodes of the second sustain electrode group and not adjacent to sustain electrodes of the first sustain electrode group.

15. The plasma display apparatus of claim 14, wherein the first and second electrode line groups are disposed on opposite sides of the first base film.

16. The plasma display apparatus of claim 14, wherein the connection circuit includes a flexible printed circuit board.

17. The plasma display apparatus of claim 14, wherein the connection circuit further comprises a second base film and the first and second electrode line groups are respectively located on the first and second base films.

18. The plasma display apparatus of claim 14, wherein the number of the sustain electrode groups is two.

19. The plasma display apparatus of claim 14, wherein during a predetermined first period of an address period, a first bias voltage is applied to the sustain electrodes of the first sustain electrode group by the first electrode line group, and a second bias voltage different from the first bias voltage is applied to the sustain electrodes of the second sustain electrode group by the second electrode line group.

20. The plasma display apparatus of claim 14, wherein the number of the whole sustain electrode lines arranged in the PDP is at least 1000.
